(19) United States
(12) Patent Application Publication
(10) Pub. No.: US 2005/0182729 A1
(43) Pub. Date: Aug. 18, 2005

(54) Method of preventing counterfeiting

(76) Inventor: Guy Max Kananen, Plymouth, MI (US)

Correspondence Address: Thomas T. Moga;BUTZEL LONG, Suite 200, 100 Bloomfield Hills Parkway, Bloomfield Hills, MI, 48304, US

(21) Appl. No.: 11/058,713

(22) Filed: Feb. 14, 2005

Related U.S. Application Data
(60) Provisional application No. 60/544,039, filed on Feb. 12, 2004.

(51) Int. Cl. H04K 1/00

(52) U.S. Cl. 705/57

(57) ABSTRACT

A method of preventing the counterfeiting of a wide variety of articles is disclosed. The method incorporates into an article a random, embedded or integrated pattern or other form of identification which can be detected and mathematically described by an algorithm to verify authenticity.

### BACKGROUND OF THE INVENTION

1. Field of the Invention

The present invention relates to a method of preventing the counterfeiting of a wide variety of articles. More particularly, the present invention relates to a method for incorporating into an article a random, embedded or integrated pattern or other form of identification which can be detected and mathematically described by an algorithm to verify authenticity.

2. Description of the Related Art

Fraud of valuable articles, particularly money and negotiable instruments, is a global problem that challenges both businesses and governments world-wide. Such valuable articles also include, for example, jewelry and purses. Several efforts have been made to overcome these problems as evidenced by U.S. Pat. Nos. 4,463,250, 5,432,506, 6,170,744, 6,181,814, 6,553,136, and 6,611,598. However, these efforts have failed to overcome the known difficulties.

### SUMMARY OF THE INVENTION

It is an object of the present invention to provide a method of preventing counterfeiting in a variety of articles.

This and other objects and advantages of the invention may be achieved by a method of providing for the verification of genuine articles, validation of their authenticity, and to prevent counterfeiting; it includes, but is not limited to: currency, money, credit cards, checks, money orders, cashier checks, traveler checks, invoices, audit reports, signature cards, receipts, proof of purchase certificates, warrants, licenses, trademarks, brand names, tags, identification cards, documents, title deeds, certificates, recordings, software, contracts, policies, stock certificates, warranties, diplomas, magazines, clothing, luggage, purses, pens, pencils, jewelry, birth certificates, death certificates, pre-certified paper for contracts, pre-certified paper for posters and prints, and discharge papers.

The present method allows for the provision of include any item, manufactured or natural, material, or abstract, that could be identified as being discreet, or unique and thus be authenticated, or verified as being genuine. The nature of the article is not important, as long as there is some fundamental randomness that can detected, or introduced into the article, that can be detected, transformed by algorithm, and then be encrypted in into a form of identification: ID number, pattern, logo, etc. Additionally, the purpose of the present invention is to prevent the counterfeiting of articles and to allow for the verification of articles, relics, artifacts; in summa, any item, article, or thing that can be identified as having a unique, or can be made or given a unique feature, even if on a molecular level, and can be assigned an encrypted algorithmic description. Practically anything can be assigned an encrypted self-verifying identifier.

In addition, the present invention includes a method of verification, the devices of verification, the implanted, or the use of the unique pattern, and or the ability to recognize and define the individual and unique patterns of a natural item, to define the individual and unique pattern by algorithm, and to encode and or encrypt the pattern, the assignment of the identification information, and including the service of decrypting and verifying the item. All these terms reference the verification process.

### DETAILED DESCRIPTION OF THE PREFERRED EMBODIMENTS

The following several embodiments of the present invention may be identified. Other variations of these embodiments are possible without exceeding the scope of the instant application.

### First Embodiment

The first embodiment relates to currency in the form of paper-like money. The present invention is not necessarily limited to the insertion or the inclusion of wire in the manufacture of paper-like money. The desired arrangement of the wire in this case may be a random and or complex pattern. Each bill would be unique, yet to the end users, still uniformly currency. If a high degree of complexity and sophistication is desired, the degree of complexity could be increased and attained by adding additional material, and or finer resolution fibers. For example, something similar to steel wool, or micro fiber could be added to the material.

An analysis would then be made of the varying relationships and intersections between the wires, fibers, printed ink, watermarks, etc. The specificity of the relationship would be determined by an algorithm. The algorithm may vary from: bill to bill, from day to day, with time, with serialization, and or with any additionally chosen variable. The algorithm may remain undisclosed and be held in security by and agent or mechanism.

Multiple algorithms and encryptions could be applied to a single bill. This is desirable. Each algorithm would be held in security by separate agents and or agencies. Each method of encryption and changing codes, would like-wise be held secure. The National Security Agency is the premier competence center in the world for this activity, and they could easily advice on the establishment of robust procedures.

The algorithm would produce a result; in this example seven digits—note, it could be any number desired. The algorithm associated with an identification number and or a serial number, and or a date manufacture. All the number may again be encrypted, depending on the desired level integrity. The digits would be included in the identification number on the bill. Multiple algorithms may used and encrypted to create extremely complex identification numbers.

Both the decryption and the algorithm may be applied to a bill via remote location using a simple reader, as at bank or a restaurant, for example, and communicate with various independent agents or mechanisms modem or similar device. The reader may vary in sophistication and cost: simple quick check may be made to low denominations, at perhaps a restaurant, while in depth confirmation and verification for high denomination bills would be conducted at perhaps a bank, while ever increasingly complex analysis could be conducted a Federal Reserve Banks.

At first, as the system evolves, the transmission may only be a simple raster image produced from high intensity light scan. Later, as experience and sophistication increases, interactivity, multiple frequencies, and other phenomenon may be introduced.

Connectivity could be handled through the internet. Both Arpanet and Milnet have acquired substantial experience in handling secure transmission, and could provide insight into establishing secure, open, anonymous, and public access, that would be sociably, financially, and commercially acceptable.

If one algorithm is compromised, its window of vulnerability is removed from the verification process, and alternate algorithms could be used. Counterfeiting a bill thus manufactured, would require a dramatic increase in capability of the counterfeiter, requiring the exact holding tolerances on tens of thousands, perhaps hundreds of thousands, of data points representing the relationships of the wires, fibers, flaws, ink, etc. But in the manufacturing process however, no such tolerances are required, only a relative stability in the bill over it's projected lifetime. In fact, the more random, and manifestly complex the arrangement, the more benefit. The counterfeiter, without the foreknowledge of which relationships are being subjected to algorithmic analysis, would necessarily need to replicate each and every discernable relationship, something that cannot be accomplished with a laser printer. The manufacturer on the other hand could choose as few or as many relationships for algorithmic transformation and encryption as they may desire or require.

### Second Embodiment

The second embodiment of the present invention provides additional features to the first embodiment. In reference to the currency discussion from the first embodiment, according to the second embodiment, the manufacturer may choose to include in addition to the wire and fiber; or to replace the wire with an additional phenomenon: that of an opacity impregnated ink, watermarks, random anomalies, etc. The same process can now be applied, using a different reader, equipment, agents, etc. The concept of using multiple phenomenon simultaneously: sandwiched, laminated, overlaid, integrated, etc. may be pursued to any desired or intended level of sophistication and or complexity.

The different phenomenon could also be observed with differing results by varying the analysis, frequency, and or intensity of the examination process; for example, changing the frequency of light. The verification tests and the results could be changed or modified after release (post-mortem) in response to various counterfeiting activity. These changes could be made as theoretical changes (as opposed to empirical). In other words, various inks, wires, fiber, and naturally occurring phenomenon, could viewed with differing results, thus adding to the field of random occurrences within the article. As counterfeiters manage to break certain codes or features, back-up or replacement test could be developed and deployed to currency already in circulation, much the same way as a software patch is implemented.

### Third Embodiment

The third embodiment is directed to paper used for original contracts and other documents, including negotiable instruments. Particularly, the above mentioned processes may be applied to the manufacturing, and verification paper be used in original contracts. Identification numbers or patterns could be applied to and or indelibly imprinted on the paper. It does not necessarily need to be an identification number, but could even be a graphic logo or border.

The readable phenomenon of the contract itself, the words and pictures, and their inherent flaws, and or the signatures, could also then be subjected a similar encrypted phenomenological algorithmic relational analysis, yield yet another encrypted graphic and or numeric output indelibly imprinted upon the contract, and thus “locking” every last pen stroke. The paper and the contract, in a manner of speaking, would be “married” together.

### Fourth Embodiment

The fourth embodiment is directed to licenses, passports, and identification cards. In reference to the same process as set forth in the third embodiment, the same process may be applied to licenses, passports, and identification cards. Any information for example may be subject to encrypted phenomenological algorithmic relational analysis and imprinting, and in effect “married” to a verified document. Photographs, finger prints, and or signatures may be “married” to passports, licenses, and identification cards.

### Fifth Embodiment

The fifth embodiment relates to use of the instant method on designer purses and luggage. In this example, a manufacturer may choose to construct their products from a material with a sufficiently complex, imbedded phenomenon. The resulting encrypted phenomenological algorithmic relational analysis and imprinting may either be numerical and or graphical.

### Sixth Embodiment

The sixth embodiment also relates to use of the instant method on designer purses and luggage. In this case, the identifying graphic may be prominently displayed, perhaps attractively designed in to the aesthetic features of the purse. Though similar, by algorithmic design, each logo, moniker, label, etc, may be unique; an added selling feature, and or benefit. This ever-changing and unique image, while still remaining classifiable and providing verification of authenticity, may itself be used and copyrighted as a trademark, and or designer label, and or pattern.

### Seventh Embodiment

The seventh embodiment relates to use of the instant method on artifacts and relics. In this example, certain aspects of an existing item, once given an endorsement of authenticity by an Authority, could then be given a seal of authenticity. The “seal” would the encrypted phenomenological algorithmic relational analysis of various readable features of the artifact. The phenomenon would vary according to the classifications of the artifact: moon rocks, paintings, fossils, rare books, historical documents, etc. Once encrypted, the seal would become a part of the artifact. As the artifacts and relics extant in the world become verified and sealed, the probability of forgery diminishes. Multiple readers and agents are again required.

### Eighth Embodiment

The eighth embodiment relates to use of the instant method on paper for printing posters and works of art. In reference to the discussion in the third and fourth embodiments, a similar process of marrying the natural phenomenon of the paper to art would occur.

In summary, the specification would preclude counterfeiting, except for exact three-dimensional replication of a specific, valid, and unique item. The process described above, can ultimately rely on the innate internal structure of the article, even down to a molecular level, and thus, would require complete replication. Partial replication could be possible, but only after multiple security agencies are compromised. In any case, a counterfeit would necessarily be made of only one article at a time, and defiantly not as the current process of running a copier machine. A single replication, once discovered in volume, would simply be precluded by nullifying the identification number; a simple and sufficient test proving fraud. Money for example, manufactured by this process could not be counterfeited, even if the counterfeiters had full access to the machinery. Even money made by the machinery would still be invalid unless the proper codes and algorithms are loaded. The technology race between the Department of the Treasury and the counterfeiters would greatly shift in favor of the Treasury. It would become a race, with random resolution and computer speed, backed by cryptology, on the side of the Treasury, and an ever more challenging manufacturing and distribution proposition for the counterfeiters.

1. A method for preventing the counterfeiting an article, the method including the steps of:
embedding into an article a random identifying device selected from the group consisting of patterns or a wire array and the like; and
reading the identifying device mathematically as described by an algorithm to verify authenticity.
